(19) United States
(12) Patent Application Publication
(10) Pub. No.: US 2011/0258550 A1
(43) Pub. Date: Oct. 20, 2011

(54) SYSTEM AND METHOD FOR GENERATING PERSISTENT SESSIONS IN A GRAPHICAL INTERFACE FOR MANAGING COMMUNICATION SESSIONS

(75) Inventors: Trung Dinh-Trong, Bedminster, NJ (US); Birgit Geppert, Basking Ridge, NJ (US); Frank Roessler, Basking Ridge, NJ (US)

(73) Assignee: Avaya Inc., Basking Ridge, NJ (US)

(21) Appl. No.: 12/978,921

(22) Filed: Dec. 27, 2010

Related U.S. Application Data
(60) Provisional application No. 61/325,103, filed on Apr. 16, 2010.

(51) Int. Cl. G06F 3/048; G06F 17/00

(52) U.S. Cl. 715/736

(57) ABSTRACT

Disclosed herein are systems, methods, and non-transitory computer-readable storage media for generating persistent sessions in a graphical user interface for managing communication sessions. A system configured to practice the method tracks interactions of a user with an automated assistant in a communication session displayed in a graphical user interface for managing communication sessions, wherein the graphical user interface displays automated assistants in a same manner as human participants. The system identifies work product produced by the interactions, associates the work product with the user, and saves the work product in a persistent communication session. The system can load work product by identifying a user in the current communication session and a current context. The system retrieves and restores the stored work product in the current communication session. The stored work product can include at least one setting associated with an automated assistant.

### RELATED APPLICATIONS

This application claims priority to U.S. Provisional Application 61/325,103, filed 16 Apr. 2010, the contents of which are herein incorporated by reference in their entirety.

### BACKGROUND

1. Technical Field

The present disclosure relates to managing communications and more specifically to persistent sessions storing work product generated from automated assistant/human interactions.

2. Introduction

As communication platforms mature and add more complexity and functionality, users, such as business users, generate collaborative work product in these communication platforms. When a communication session terminates, however, this work product and a particular configuration of the communication space in the platform is typically saved piecemeal and some configuration aspects are not saved at all. If the users wish to resume a previous session, they must first identify which pieces of work product are needed, remember the previous configuration, locate the necessary information and resources, and so forth. This approach is not efficient and can waste significant amounts of time for all participants. Not only that, but the exact configuration of the communication session may be lost altogether, resulting in an unfamiliar environment and a sense of discontinuity across communication sessions.

Further, a particular configuration of automated assistants, information, and other resources may be convenient for a particular task or communication session. Users must remember and manually recreate or reestablish these convenient configurations. This manual step reduces the convenience of robots and the communication platform, wastes user time, and can make users less enthusiastic about using the communication platform.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for generating a persistent session in a graphical user interface for managing communication sessions. A system configured to practice the method tracks interactions of a user with an automated assistant in a communication session displayed in a graphical user interface for managing communication sessions, wherein the graphical user interface displays automated assistants in a same manner as human participants. The system identifies work product produced by the interactions, and associates the work product with the user. Then the system saves the work product in a persistent communication session for later use by the user. The system can save the work product when the communication session terminates, or save the work product at an initial time in the communication session and update the saved work product throughout the communication session.

In another embodiment, the system loads work product from a previous communication session associated with a current communication session. The system identifies a user in the current communication session and identifies a current context for the user and the current communication session. The system retrieves stored work product associated with the user and the current context, wherein the stored work product was generated in a previous communication session that occurred before the current communication session. Then the system restores the stored work product in the current communication session in a graphical user interface that displays automated assistants in a same manner as human participants, wherein the stored work product includes at least one setting associated with an automated assistant.

This disclosure focuses on the context, placement, and specific timing aspects of robots and other resources in a communication session, such as working with real people and saving work output for future use with a persistent session or an associated session. As one example, a robot can save a particular configuration, such as a set of users, sets of input data, working documents, dialog history, robot/participant placement on a UI, and so forth, in a package associated with one or more context or aspect of the context. A user can review, delete, share, copy, or update these packages. The packages can be separate files, can be associated with a persistent session, can be associated with a particular robot or robot(s), and so forth. The user can load a particular package of robots, work output, and so forth by clicking a button or entering some other input. Alternatively, the system analyzes user information (such as a calendar or a current context) to deduce what package the user is likely to need in order to suggest opening or to automatically open that package.

As another example, robots can be added when needed and removed when not needed, and can be shown through an “added by” dotted line linking to the person who added the bot. Further, the robot can produce work in cooperation with live people and the work produced can appear as a saved and associated icon for future use in a persistent session or associated sessions. Another aspect is when a robot stands between two human users or part of a side bar for a sub-group of human users. This placement or positioning of the robot between the users can be stored and retrieved as part of the persistent session.

Another focus is a fully flexible automation framework that allows events, calendars, and/or session markers to fetch and place the robots individually or based on a particular context, placement, and specific timing. The automation here can be an event trigger, a sort of calendar for the robot, session markers that call robots when a specific pre-defined point in the session is reached (such as a particular agenda item), etc. One aspect of this disclosure is a framework that has a fully flexible automation construct that allows events, calendars, and/or session markers to fetch, place, and feed data to robots.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2A illustrates a first exemplary user interface for managing a first communication session with human and automated assistant participants at a first time;

FIG. 2B illustrates a second exemplary user interface for managing the first communication session at a second time after work product has been generated by interaction between a human and an automated participant;

FIG. 3 illustrates an exemplary stored session including work product;

FIG. 4 illustrates an exemplary user interface for managing a second communication session after the first communication session;

FIG. 5 illustrates a first example method embodiment for saving work product in a communication session; and

FIG. 6 illustrates a second example method embodiment for restoring saved work product in a communication session.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

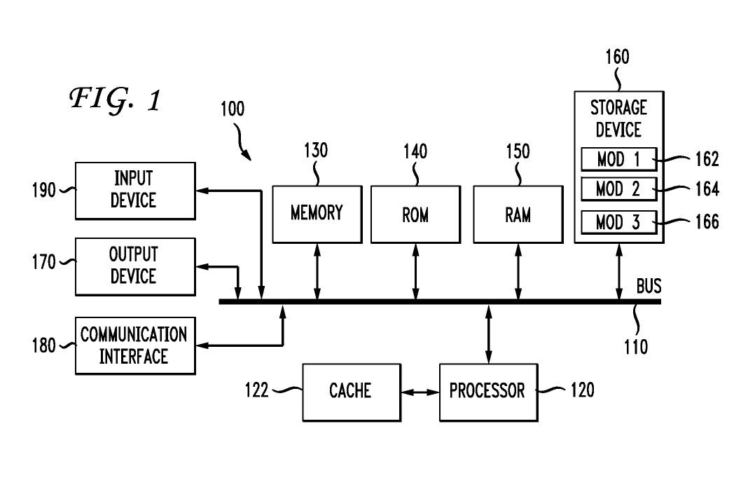

The present disclosure addresses the need in the art for a more convenient way to save a particular configuration of resources and/or work product in a communication session. A brief introductory description of a basic general purpose system or computing device in FIG. 1 which can be employed to practice the concepts is disclosed herein. A more detailed description of the various approaches and user interfaces will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of persistent communication sessions. As humans interact with robots in a graphical interface for managing one or more communication sessions, they produce work output such as documents, information, a particular configuration of robots, and so forth. This approach saves all or part of that work output for use in a persistent session or for replication in an associated session. The graphical user interface represents autonomous agents, automated assistants, or robots in a graphical call connection graph in the same manner as human participants. While the exemplary user interfaces disclosed herein are based on a spoke representation of a call connection graph, the actual graphical user interface can be of any type, including a spotlight-based interface or a list-based interface.

The persistent communication session can store context, position, and/or specific timing elements of automated assistants in the communication session. The system can add and remove automated assistants as needed. The system can illustrate the relationship of the automated assistant to a particular triggering event or person in the form of a dotted line, overlap, and/or other visual enhancement to the automated assistant. Automated assistants can generate work product as a byproduct of cooperation with human participants and/or at the direction of human participants. That work product can appear as a saved and/or associated icon for future use in a persistent session or associated session.

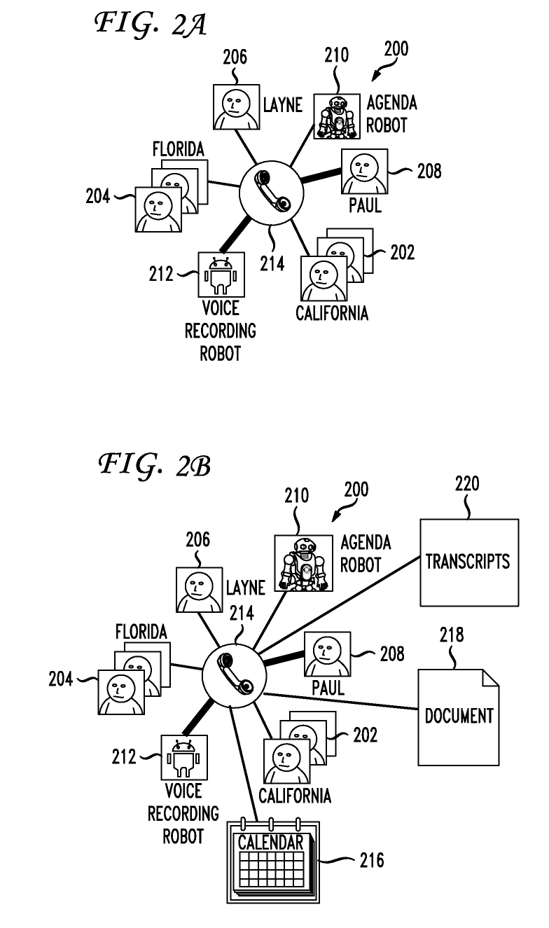

FIG. 2A illustrates a first exemplary user interface 200 for managing a first communication session with human and automated assistant participants at a first time. The user interface 200 represents a communication session between a first group of human participants in California 202, a second group of human participants in Florida 204, Layne 206, and Paul 208. Two “robots”, or automated assistants, are part of the communication session as well: an agenda robot 210 and a voice recording robot 212. The communication session is a telephone conference, as denoted by the telephone icon in the hub 214 of the user interface 200. While this exemplary user interface 200 is based on a hub, the same principles also apply to other user interface approaches for displaying a communication graph, such as a spotlight-based approach, for example.

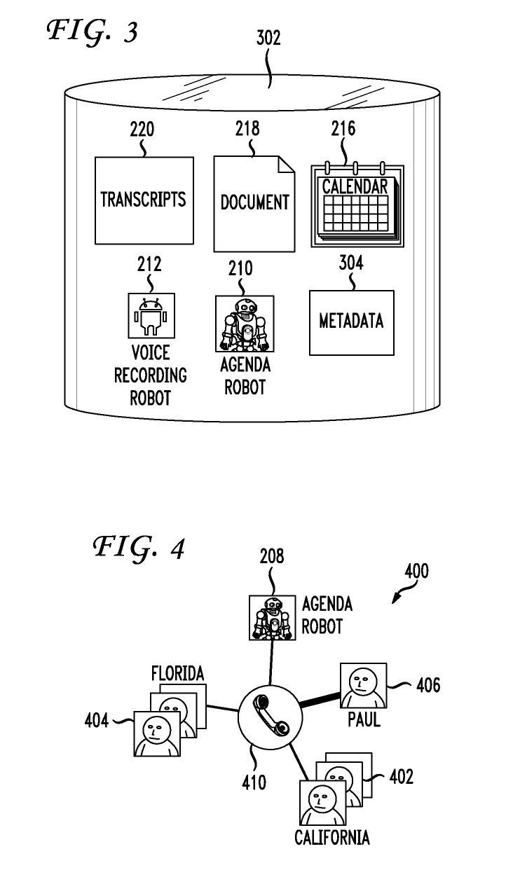

FIG. 2B illustrates a second exemplary user interface for managing the first communication session at a second time after work product has been generated by interaction between a human and an automated assistant. As the human participants 202, 204, 206, 208 collaborate and interact with each other and with the automated assistants 210, 212, work product is generated. The work product can include many different kinds of information and configuration data. FIG. 2B illustrates exemplary work product such as a calendar 216, a document 218, and transcripts 220 of the communication session. The work product can also include the positioning and timing of the automated assistants 210, 212. Some time before the termination of or upon the termination of the communication session, the system can generate a stored session 302 including all or part of the work product 210, 212, 216, 218, 220, as shown in FIG. 3. The work product can include a list of human participants as well. The stored session 302 can be a persistent communication session that the previous human participants and/or others can rejoin. Users can import the stored session 302 into an entirely new communication session. The stored session 302 can also include metadata 304 describing various aspects of the communication session, including participants and participant attributes, automated assistants and their attributes, work product, a communication history, a list of users authorized to view, manage, use, and/or retrieve the stored session 302, and so forth.

For example, FIG. 4 illustrates an exemplary user interface 400 for managing a second communication session after the first communication sessions shown in FIGS. 2A and 2B. The second communication session includes Paul 406 as well as the groups from California 402 and from Florida 404. The second communication session is a telephone conference 410. In one aspect, one of the users selects and retrieves (or joins) the stored session 302, bringing up all or part of the stored work product into the second communication session. The system can retrieve the work product from the stored session based on a user request and/or based on a threshold similarity of a current context to a context of the stored session.

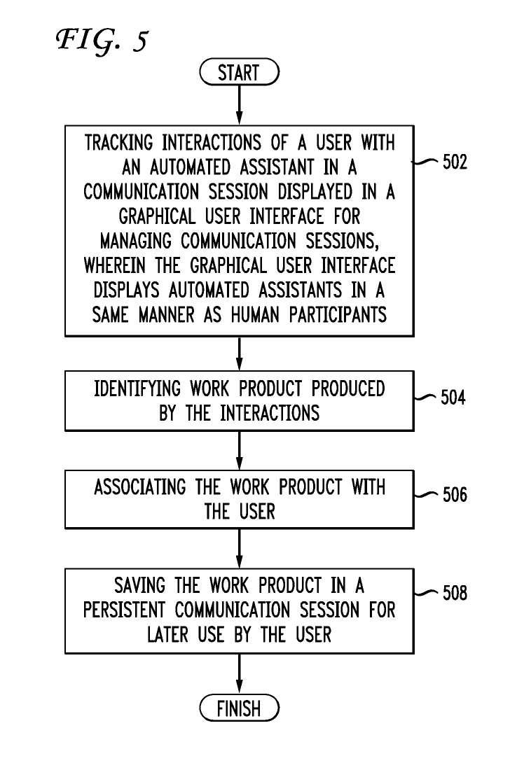

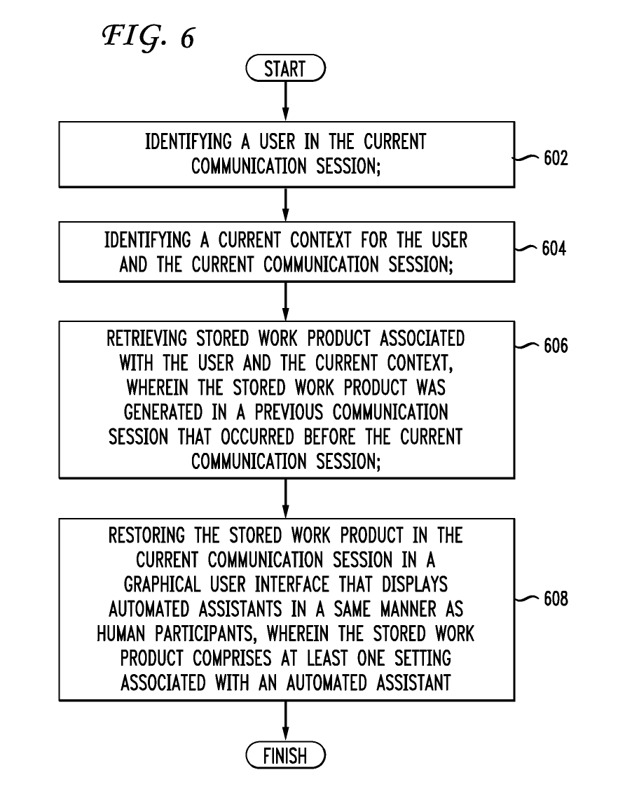

Having disclosed some basic system components and concepts, the disclosure now turns to the exemplary method embodiments shown in FIGS. 5 and 6. For the sake of clarity, the methods are discussed in terms of an exemplary system 100 as shown in FIG. 1 configured to practice the respective methods. The steps outlined herein are exemplary and can be implemented in any combination thereof, including combinations that exclude, add, or modify certain steps.

FIG. 5 illustrates a first example method embodiment for saving work product from a communication session. The system 100 tracks interactions of a user with an automated assistant in a communication session displayed in a graphical user interface for managing communication sessions, wherein the graphical user interface displays automated assistants in a same manner as human participants (502). The graphical user interface can provide a user with a way to manage multiple communication sessions in a single interface. Automated assistants and human participants are displayed in the same manner in this user interface. That is, if human participants are shown as a set of connected icons, then automated assistants are also displayed as an icon in the set of connected icons, or if human participants are shown as icons under a spotlight, then automated assistants are displayed in the same way. Similarly, the user interface allows users to interact with other users in the same way as with automated assistants.

Then the system 100 identifies work product produced by the interactions (504). The work product can include, for example, a document, information, a set of automated assistants, a communication history, a set of human participants, an image, multimedia content, a transcript, an agenda, and a calendar. The work product can also include context, placement, specific timing, associations with particular users, settings, usage history, and metadata associated with automated assistants in the communication session. The context, placement, and specific timing of the automated assistant can be associated with the user and at least one other participant in the communication session. The system 100 associates the work product with the user (506) and saves the work product in a persistent communication session for later use by the user (508). The user interface can display the work product as an icon. The system 100 can transfer the work product to a related communication session. For example, the system 100 can duplicate the work product in the related communication session, share the work product between the communication session and the related communication session, and/or move the work product from the communication session to the related communication session.

FIG. 6 illustrates a second example method embodiment for restoring saved work product in a communication session. A system 100 practicing this method first identifies a user in the current communication session (602) and identifies a current context for the user and the current communication session (604). Then the system 100 retrieves stored work product associated with the user and the current context, wherein the stored work product was generated in a previous communication session that occurred before the current communication session (606). The system 100 restores the stored work product in the current communication session in a graphical user interface that displays automated assistants in a same manner as human participants, wherein the stored work product comprises at least one setting associated with an automated assistant (608). This allows users to continue working in a previously established persistent communication session or to adapt a new communication session to match a previous communication session. This approach allows a user to continue working in a familiar situation, including previous work product, a set of automated assistants, a particular configuration for that set of automated assistants, a group of human participants, and so forth.

The solutions and approaches set forth herein allow users to save a particular configuration of robots, context, work product, and collaborative space for reuse. Users having multiple clearly defined workflows for specific contexts can benefit greatly from a persistent communication session optimized for each workflow. This approach allows users to easily resume a particular configuration of robots and their outputs as part of a persistent session based on context, position, and specific timing.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of generating a persistent session in a graphical user interface for managing communication sessions, the method comprising:
tracking interactions of a user with an automated assistant in a communication session displayed in a graphical user interface for managing communication sessions, wherein the graphical user interface displays automated assistants in a same manner as human participants;
identifying work product produced by the interactions;
associating the work product with the user; and
saving the work product in a persistent communication session for later use by the user.

2. The method of claim 1, wherein the work product comprises at least one of a document, information, a set of automated assistants, a communication history, a set of human participants, an image, multimedia content, a transcript, an agenda, and a calendar.

3. The method of claim 1, further comprising transferring the work product to a related communication session.

4. The method of claim 3, wherein transferring the work product to the related communication session comprises at least one of duplicating the work product in the related communication session, sharing the work product between the communication session and the related communication session, and moving the work product from the communication session to the related communication session.

5. The method of claim 1, wherein the work product comprises at least one of context, placement, and specific timing of the automated assistant in the communication session.

6. The method of claim 5, wherein the context, placement, and specific timing of the automated assistant are associated with the user and at least one other participant in the communication session.

7. The method of claim 1, wherein the user interface displays the work product as an icon.

8. A non-transitory computer-readable storage medium storing instructions which, when executed by a computing device, cause the computing device to load work product associated with a current communication session, the instructions comprising:
identifying a user in the current communication session;
identifying a current context for the user and the current communication session;
retrieving stored work product associated with the user and the current context, wherein the stored work product was generated in a previous communication session that occurred before the current communication session; and
restoring the stored work product in the current communication session in a graphical user interface that displays automated assistants in a same manner as human participants, wherein the stored work product comprises at least one setting associated with an automated assistant.

9. The non-transitory computer-readable storage medium of claim 8, wherein the stored work product further comprises at least one of a document, information, a set of automated assistants, a communication history, a set of human participants, an image, multimedia content, a transcript, an agenda, and a calendar.

10. The non-transitory computer-readable storage medium of claim 8, further comprising transferring the stored work product to a related communication session.

11. The non-transitory computer-readable storage medium of claim 10, wherein transferring the stored work product to the related communication session comprises at least one of duplicating the stored work product in the related communication session, sharing the stored work product between the communication session and the related communication session, and moving the stored work product from the communication session to the related communication session.

12. The non-transitory computer-readable storage medium of claim 8, wherein the stored work product further comprises at least one of context, placement, and specific timing of the automated assistant in the current communication session.

13. The non-transitory computer-readable storage medium of claim 12, wherein the context, placement, and specific timing of the automated assistant are associated with the user and at least one other participant in the current communication session.

14. The non-transitory computer-readable storage medium of claim 8, wherein the user interface displays the stored work product as an icon in the current communication session.

15. A system for generating and restoring a persistent session in a graphical user interface for managing communication sessions, the system comprising:
a processor;
a first module configured to control the processor to track interactions of a user with an automated assistant in a first communication session at a first time displayed in a graphical user interface for managing communication sessions, wherein the graphical user interface displays automated assistants in a same manner as human participants;
a second module configured to control the processor to identify work product produced by the interactions;
a third module configured to control the processor to associate the work product with the user;
a fourth module configured to control the processor to save the work product in a persistent communication session;
a fifth module configured to identify a second communication session associated with the first communication session, the second communication session occurring at a second time that is later than the first time; and
a sixth module configured to control the processor to restore the persistent communication session as part of the second communication session.

16. The system of claim 15, wherein the work product comprises at least one of a document, information, a set of automated assistants, a communication history, a set of human participants, an image, multimedia content, a transcript, an agenda, and a calendar.

17. The system of claim 15, wherein restoring the persistent communication session comprises at least one of duplicating the work product in the related communication session, sharing the work product between the communication session and the related communication session, and moving the work product from the communication session to the related communication session.

18. The system of claim 15, wherein the work product comprises at least one of context, placement, and specific timing of the automated assistant in the first communication session.

19. The system of claim 18, wherein the context, placement, and specific timing of the automated assistant are associated with the user and at least one other participant in the first communication session.

20. The method of claim 1, wherein the user interface displays the work product as an icon.
